(19) United States
(12) Patent Application Publication
(10) Pub. No.: US 2026/0170055 A1
(43) Pub. Date: Jun. 18, 2026

(54) APPARATUS AND METHOD FOR VIDEO MOMENT RETRIEVAL AND HIGHLIGHT DETECTION USING INVERTED TOKEN AUGMENTATION

(71) Applicant: ELECTRONICS AND TELECOMMUNICATIONS RESEARCH INSTITUTE, Daejeon (KR)

(72) Inventors: Jong Hee KIM, Daejeon (KR); Jin Young MOON, Daejeon (KR); Yong Jin KWON, Daejeon (KR); Dae Hoe KIM, Daejeon (KR); Sung Chan OH, Daejeon (KR); Je Seok HAM, Daejeon (KR); Chang Jun OH, Seoul (KR); Jun Yeong KIM, Seoul (KR)

(21) Appl. No.: 19/321,916

(22) Filed: Sep. 8, 2025

(30) Foreign Application Priority Data
Dec. 16, 2024 (KR) 10-2024-0186812

(51) Int. Cl. G06F 16/783; G06V 20/40

(52) U.S. Cl. CPC G06F 16/783; G06V 20/49

(57) ABSTRACT

A method and a device for video moment retrieval and highlight detection may include obtaining an inverted token of a text query based on an original token of the text query, obtaining video feature vectors of video clips, and performing an interaction between the text query and video clips by simultaneously using the original token, the inverted token and the video feature vectors.

### CROSS-REFERENCE TO RELATED APPLICATION(S)

This application claims the benefit of earlier filing date and right of priority to Korean Application No. 10-2024-0186812, filed on Dec. 16, 2024, the contents of which are all hereby incorporated by reference herein in their entirety.

### BACKGROUND OF THE INVENTION

### 1. Field of the Invention

The present disclosure may provide a technology for accurately retrieving a specific moment in a video or automatically detecting an important moment in video data according to a text-based query. It may be utilized to analyze and process video data in a deep learning-based artificial intelligence system by integrating computer vision (CV) and natural language processing (NLP). This technology has recently emerged as an important research topic along with an explosive increase in data, and is becoming an essential element in various multimedia applications such as video retrieval, automatic summarization, video indexing, content recommendation systems, etc.

### 2. Description of Related Art

Video data includes much more information than text or video data, and it may be very complicated to process and analyze because it includes not only visual information but also temporal and spatial information. In particular, retrieving a specific moment in video data or automatically extracting an important moment is emerging as an important and very difficult problem according to a specific query (text).

The existing video moment retrieval (MR) and highlight detection (HD) techniques may be performed by aligning text queries and video clips. Generally, these techniques focus on simply matching a text and a video, but in many cases, they may have difficulty in obtaining a desired result due to the selection of irrelevant clips or inaccurate matching between a query and a video clip.

### SUMMARY OF THE INVENTION

The main purpose of the present disclosure is to improve performance in highlight detection and moment retrieval tasks by precisely refining an interaction between a text query and a video clip. In particular, it is the key purpose of the present disclosure to prevent a video clip that incorrectly matches some elements of a text query and ensure that the important part of a text query is accurately reflected.

In order to achieve this, the present disclosure may introduce three major technical techniques, Inverted Token Augmentation, Token Influence Tracing and Highlight-guided Anchor Initialization, to provide a method for enabling a precise interaction between a text query and a video clip and improving the performance of video moment retrieval (MR) and highlight detection (HD) tasks.

A method and a device for video moment retrieval and highlight detection may include obtaining an inverted token of a text query based on an original token of the text query, obtaining video feature vectors of video clips, and performing an interaction between the text query and video clips by simultaneously using the original token, the inverted token and the video feature vectors.

In a method and a device for video moment retrieval and highlight detection, the inverted token may be generated by reversely converting a sign of the original token.

In a method and a device for video moment retrieval and highlight detection, the interaction may be performed by a cross-attention layer.

A method and a device for video moment retrieval and highlight detection may further include obtaining a final feature of each clip of the video clips based on a final token obtained through the interaction.

In a method and a device for video moment retrieval and highlight detection, when a query token of the text query is more similar to a second key token generated from the original token than to a first key token generated as the inverted token, the final feature may be added to the final token and obtained by using a value token as a positive weight.

In a method and a device for video moment retrieval and highlight detection, when the query token of the text query is more similar to the first key token generated as the inverted token than to the second key token generated from the original token, the final feature may be added to the final token and obtained by using the value token as a negative weight.

In a method and a device for video moment retrieval and highlight detection, when the query token of the text query is irrelevant to a key token, the value token may not influence the obtaining of the final feature.

A method and a device for video moment retrieval and highlight detection may further include calculating a highlight score based on a similarity between a global token obtained based on the interaction and the final feature and setting an initial anchor point for moment retrieval based on the highlight score.

In a method and a device for video moment retrieval and highlight detection, setting the initial anchor point may be performed by dividing the video clips into blocks having a certain interval, selecting a clip with the highest highlight score in each block and setting it as an initial anchor point of each block.

In a method and a device for video moment retrieval and highlight detection, a method for obtaining the similarity may be learned through a highlight score calculation loss function.

In a method and a device for video moment retrieval and highlight detection, the highlight score calculation loss function may use a predicted highlight score of clips.

A method and a device for video moment retrieval and highlight detection may further include tracing an influence of the original token and the inverted token.

In a method and a device for video moment retrieval and highlight detection, tracing the influence of the original token and the inverted token may be performed to ensure that for a video clip with a high relevance among the video clips, the clip is relatively more influenced by the original token, and for a video clip with a low relevance among the video clips, the clip is relatively more influenced by the inverted token.

In a method and a device for video moment retrieval and highlight detection, a result confirmed by tracing the influence of the original token and the inverted token may be used to train a model by utilizing a token influence loss function.

In a method and a device for video moment retrieval and highlight detection, the token influence loss function may be used to train the model based on an actual highlight score value of each clip and an influence received from a corresponding token.

### Technical Effect

An inverted token augmentation technique may allow each video clip to selectively reflect text information according to a relationship with a text by using a token obtained by inverting the existing text token together. In addition, this method may lead a clip with a high relevance to a query to utilize more information of an original text token and lead a clip with a low relevance to utilize more information of an inverted token, enabling a precise interaction between a text and a video.

A token influence tracing technique may identify a relationship between a video clip and a text query more precisely than the existing simple interaction method and help better reflect text information relevant to itself. Through this, the influence of information irrelevant to a text on the representation of a clip may be effectively reduced.

In addition, the tracing of the influence of a token in the present disclosure may be performed by comparing an influence received by each video clip from an original token and an inverted token when a model generates a final feature in a learning step and checking the degree thereof.

A highlight-guided anchor initialization technique may be proposed to set the initial anchor point of the moment retrieval based on a highlight detection task. A retrieval anchor may be set by utilizing important clips predicted through highlight detection, significantly improving retrieval performance and accurately finding an important moment without missing it.

### BRIEF DESCRIPTION OF THE DRAWINGS

FIG. 1 shows an embodiment of an inverted token augmentation method.

FIG. 2 shows an embodiment of a token influence tracing method.

FIG. 3 shows an embodiment of a highlight-guided anchor initialization method.

FIG. 4 shows an embodiment of an overall network structure.

FIG. 5 shows alignment refinement effects due to inverted token augmentation.

FIG. 6 shows the moment retrieval and highlight detection performance comparison with the prior art.

### DETAILED DESCRIPTION OF THE INVENTION

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference sign is used for a similar component while describing each drawing.

A term such as first, second, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term, and/or, includes a combination of a plurality of relative entered items or any item of a plurality of relative entered items.

When a component is referred to as being “linked” or “connected” to other component, it should be understood that it may be directly linked or connected to other component, but other component may exist in the middle. On the other hand, when a component is referred to as being “directly linked” or “directly connected” to other component, it should be understood that other component does not exist in the middle.

As a term used in this application is only used to describe a specific embodiment, it is not intended to limit the present disclosure. Expression of the singular includes expression of the plural unless it clearly has a different meaning contextually. In this application, it should be understood that a term such as “include” or “have”, etc. is to designate the existence of features, numbers, steps, motions, components, parts or their combinations entered in a specification, but is not to exclude the existence or possibility of addition of one or more other features, numbers, steps, motions, components, parts or their combinations in advance.

The recent techniques such as Moment-DETR [1] proposed a new framework for processing MR and HD tasks based on a DETR (Detection with Transformer) model, but there was a problem that a clip irrelevant to a query is wrongly selected because an interaction between a text query and a video clip is still not properly performed due to a self-attention-based alignment. This problem may occur because an interaction between a text and a video is simply performed and a video clip is not properly connected to some elements of a text query.

In order to solve this problem, models such as QD-DETR [2] have recently attempted to strengthen an interaction between a text and a video by introducing a cross-attention mechanism. However, this method also still inaccurately matches some text tokens and clips, and a text token is also frequently propagated to an irrelevant clip. It may cause all tokens of a text query to overwrite query text information even on an actually irrelevant clip, while interacting with a video clip in the same way. It may lower retrieval accuracy and also degrade the performance of highlight detection.

TABLE 1

| | Query-video | |
|---|---|---|
| | Alignment | |
| Model | Method | Tendency |
| Moment-DETR | Self-attention | A query sentence and each clip |
| (Comparative | | feature are aligned in one self- |
| Model 1) | | attention, and are attended only in |
| | | each modality. |
| QD-DETR | Cross-attention | A clip with a low relevance and a |
| (Comparative | | sentence are aligned through an |
| Model 2) | | alignment regardless of a similarity |
| | | between a query sentence and each |
| | | clip. |
| Proposed | Cross-attention with | When a query sentence and clips |
| Method | Inverted Token | are irrelevant, irrelevant clips |
| | Augmentation | pay attention to an inverted |
| | | token, and only clips with a high |
| | | relevance are aligned. |

The present disclosure may introduce three major technical techniques, Inverted Token Augmentation, Token Influence Tracing and Highlight-guided Anchor Initialization, to provide a method for enabling a precise interaction between a text query and a video clip and improving the performance of video moment retrieval (MR) and highlight detection (HD) tasks. Each component of the present disclosure is comprised as follows.

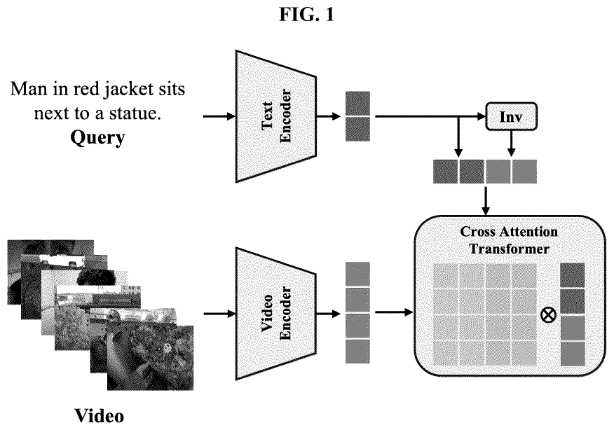

FIG. 1 shows an embodiment of an inverted token augmentation method.

Inverted token augmentation may be a technique for refining an interaction with a video clip by using the original token of a text query and its inverted token together. In the existing video moment retrieval and highlight detection tasks, all tokens of a text query interact with a video clip with the same importance, which may cause an error in which a text element with a low relevance is emphasized or information of an irrelevant query (word) is propagated to each clip.

In order to solve it, the present disclosure introduces an inverted token. An inverted text token (=inverted token) is generated by reversely converting the sign of an original text token (=original token), which may prevent the improper part of a irrelevant query from being propagated to each video clip. Specifically, by using an original text token and an inverted token together in the cross-attention layer of a network as follows, an interaction between a text and a video clip may be controlled more precisely.

A cross-attention layer may be performed in a cross-attention transformer.

In addition, the original token of a text query may be obtained through a text encoder, and an inverted token may be obtained based on an original token in an inverter.

In addition, video clips may be obtained through a video encoder. Specifically, a video encoder may obtain video feature vectors of video clips which can be used for the interaction between the text query and the video clips.

$${V}^{l + 1} = MHCA ( {V}^{l} , T \vert \vert - T , T \vert \vert - T ) \\ {V}^{l} , T : Feature vector of l - th layer , text feature vector \\ MHCA ( \cdot ) : Multi - head Cross Attention \\ \vert \vert : Concatenation$$

The attention allocated to each token within the multi-head cross attention is obtained through Softmax as follows, and may be calculated by multiplying a corresponding token by each attention weight and adding it. A final token may be obtained based on attention allocated to each token, and a final feature may be obtained based on a final token.

$${\tilde{V}}^{{}_{l}} = Softmax ( Q ( {V}^{l} ) {K ( T \vert \vert - T )}^{T} ) V ( T \vert \vert - T ) \\ {\tilde{V}}^{{}_{l}} : attention results of l - th layer \\ Q ( \cdot ) , K ( \cdot ) , V ( \cdot ) : linear layer mapping to Query , Key , Value in MHCA$$

Here, the result of MHCA may be as follows for the i-th Query and the j-th Key and Value.

$${\tilde{V}}_{i , j}^{{}_{\text{?}}} = \frac{exp ( {q}_{i} {k}_{j} ) - exp ( - {q}_{i} {k}_{j} )}{{\sum }_{n = 1}^{{N}_{T}} exp ( {q}_{i} {k}_{n} ) + exp ( - {q}_{i} {k}_{n} )} {v}_{j} \\ {q}_{i} : Query token of i - th token \\ {k}_{j} , {v}_{j} : Key token and value token of j - th token$$

$$\text{?} \text{indicates text missing or illegible when filed}$$

According to an attention operation method above, a method in which the value of each token influences a final feature may be divided into three types.

1) qᵢkⱼ>0>−qᵢkⱼ, i.e., when a query token is more similar to the key token of an original token than the key token of an inverted token, a value token may be added to a final token as a positive weight.

2) qᵢkⱼ=0=−qᵢkⱼ, i.e., when a query token and a key token are irrelevant, a value token may not influence a final feature. Here, a key token may be at least one of the key token of an original token or the key token of an inverted token.

3) qᵢkⱼ<0<−qᵢkⱼ, i.e., when a query token is more similar to the key token of an inverted token than the key token of an original token, it may be added to a final token as a negative weight.

By performing these three operations, it may show a different aspect from the existing cross-attention where it is always added as a positive weight regardless of a similarity between tokens.

As an embodiment, in a text query “A woman with a yellow bag is walking”, an original text token may be composed of [woman], [yellow], [bag] and [walk]. In this case, an inverted token may be generated by reversing the sign of text tokens of [woman], [yellow], [bag] and [walk], respectively.

As an embodiment, for an original key token and an inverted key token corresponding to each value token, a similarity with the query token of a video clip may be compared. Based on the result of similarity comparison, a corresponding value or a value obtained by applying a similarity to a value (e.g., a value obtained by multiplying a similarity) may be added to a final token. In this case, when a similarity with an original key token is higher than a similarity with an inverted key token, a corresponding value may be added as a positive weight, and conversely, when a similarity with an inverted key token is higher than a similarity with an original key token, it may be added as a negative weight.

An inverted token may prevent a clip from focusing only on the original token of a text when a corresponding clip incorrectly matches a query, and may prevent a wrong interaction by focusing on an inverted token.

In this way, a video clip may be appropriately aligned based on the actual importance and relevance of a query, and information irrelevant to each clip may not be propagated in the process of interacting with a text query. It is a method that is differentiated from the existing cross-attention mechanism, which may greatly improve retrieval and detection performance by reducing the propagation of unnecessary information.

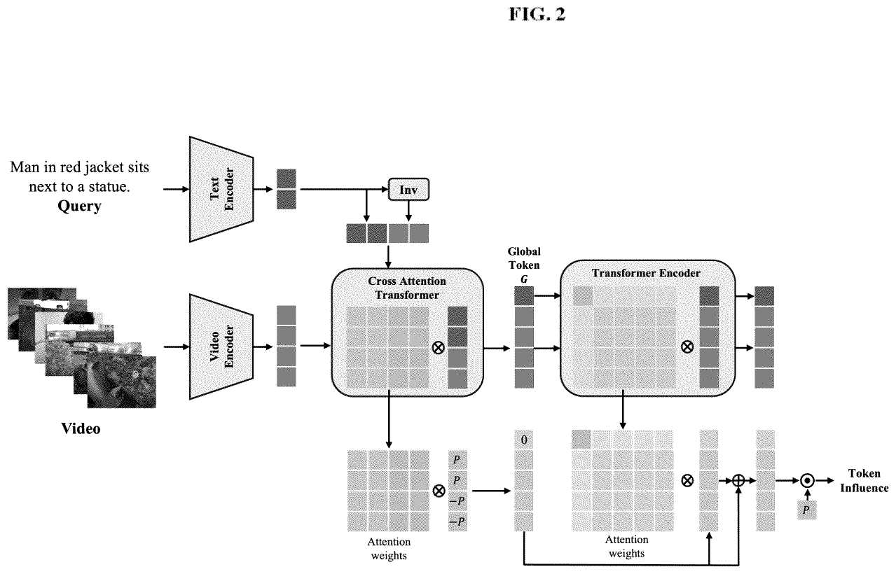

FIG. 2 shows an embodiment of a token influence tracing method.

Token influence tracing may be a technique for tracing how the original token and inverted token of a text query influence a video clip across the network.

Token influence tracing may be performed by a token influence tracer.

The present disclosure may trace an interaction between a text and a video clip at each layer of a network to finally calculate whether each video clip is more influenced by the original token or the inverted token.

Specifically, in order to trace token influence in a cross-attention layer, an interaction for an original text token and an inverted text token may be accumulated respectively as follows (or, the influence value or influence score of a token may be derived). A token influence tracing process may be performed in a method for training a model to ensure that a video clip with a high relevance is relatively more influenced by an original text token and a clip with a low relevance is relatively more influenced by an inverted text token based on the influence value of the accumulated tokens. As an example, a method for applying the influence value or influence score of a token may include the first method for adding the influence value or influence score of a token, the second method for using the influence value or influence score of a token as a weight and the third method for mixing the first method and the second method.

A model learned through token influence tracing may be utilized for the cross-attention layer of the present disclosure, and a value by a learned model may be reflected on a final feature.

In this case, a method for paying attention (or a method for utilizing the influence value or influence score of a token) may be learned through a token influence loss function described later.

$${S}^{l + 1} = {S}^{l} + Softmax ( Q ( {V}^{l} ) {K ( T \vert \vert - T )}^{T} ) {S}^{0} \\ {S}^{l} : influence of each token of the l - th layer$$

This technique strengthens an interaction between a text and a clip through cross-attention at each layer of a network, and in the last layer, it may be utilized for learning by measuring whether each clip is more influenced by an original token or an inverted token. Through this, a model may help align each clip more effectively according to its relevance to a text query.

This method may control the information of a text query to prevent it from being propagated to a video clip irrelevant to a text query more precisely than the existing simple interaction method. A token influence tracing technique plays a key role in the present disclosure, and help effectively learn alignment between a video clip and a text.

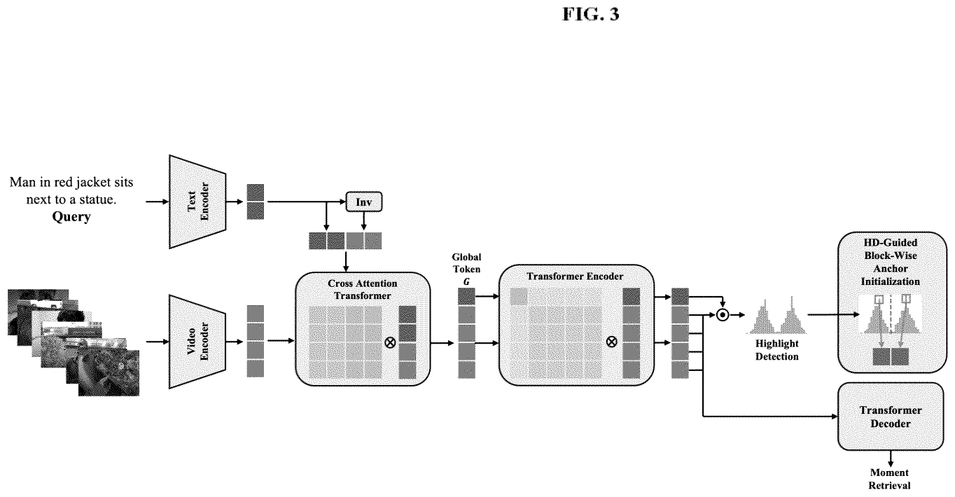

FIG. 3 shows an embodiment of a highlight-guided anchor initialization method.

Another important element in the present disclosure may be a highlight-guided anchor initialization technique. Highlight detection is a task of finding an important moment in a video, and may be closely associated with a moment retrieval task. Highlight detection determines whether the specific clip of video data is an important clip, and the present disclosure may utilize this information to more efficiently set the initial anchor of moment retrieval.

Highlight-guided anchor initialization may work as follows. First, it may divide a video into several blocks, and select a clip with the highest highlight score in each block and set it as the initial anchor point of each block. Unlike the existing method for randomly setting an anchor, this method preferentially considers an important clip based on a highlight score, greatly improving the accuracy of the retrieval.

For example, when clips with a high highlight score are set as an initial anchor based on a highlight score calculated for each clip in a sports game, these anchors may be used as a reference point representing an important moment. An initial anchor set in this way may prevent duplication between anchors, greatly improve retrieval performance and enable accurate retrieval without missing an important moment.

In the existing moment retrieval method, an anchor point is randomly arranged or is set in a predefined manner, so there may be a case where an important clip is missed or an unnecessary clip is selected as an anchor. However, since the highlight-guided anchor initialization technique of the present disclosure directly utilizes a highlight detection result to set an anchor point, it may perform more efficient and accurate retrieval.

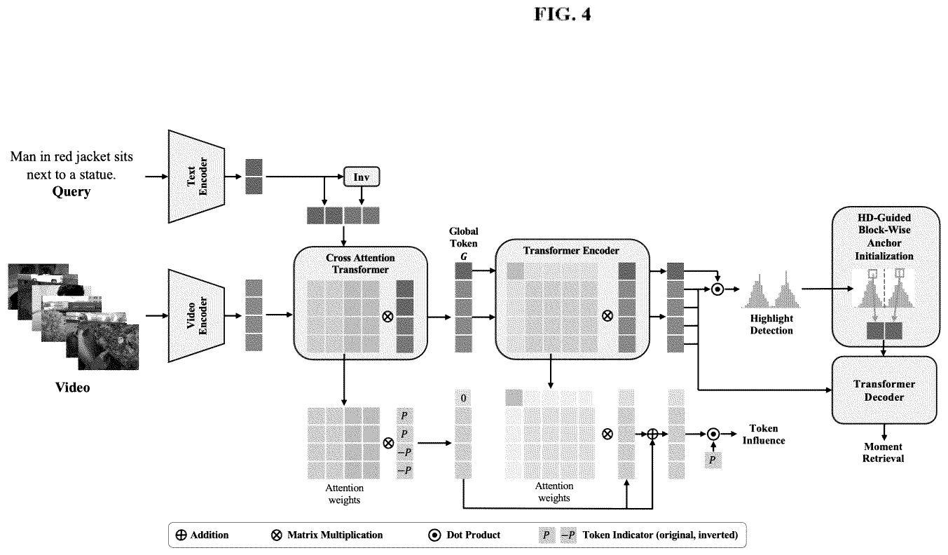

FIG. 4 shows an embodiment of an overall network structure.

The inverted token augmentation, token influence tracing and highlight-guided anchor initialization techniques proposed in the present disclosure may work by being integrated into the existing deep learning network structure. A network may take a text query and video data as input, and the text query may be processed by a text encoder and the video data may be processed by a video encoder.

Afterwards, a process may be added in which a text token and a video clip interact in a cross-attention layer and a feature is advanced through a self-attention layer. A final feature may be used to calculate a highlight score and retrieve a moment. In this process, an inverted token augmentation technique and a token influence tracing technique may be applied.

The text token of the present disclosure may include an original token and an inverted token obtained from the original token.

A highlight score is calculated through a similarity between a global token and a final feature as follows, and a model may be learned by using a highlight score calculation loss function below to learn score calculation.

$${L}_{hd} = {λ}_{margin} {L}_{margin} + {λ}_{cont} {L}_{cont} \\ {L}_{margin} = max ( 0 , Δ + {H}^{low} - {H}^{high} ) \\ {H}_{i} = \frac{{W}_{G}^{T} G \cdot {W}_{V}^{T} {V}_{i}^{L}}{\sqrt{D}} \\ {λ}_{margin} , {λ}_{cont} : Weights of each loss function \\ {L}_{margin} : Margin loss \\ {L}_{cont} : Rank - aware contrastive loss \\ Δ : margin$$

H^{low} may be the predicted highlight score of clips that must have a low highlight score value. H^{high} may be the predicted highlight score of clips that must have a high highlight score value.

The highlight score calculation loss function may use the predicted highlight score of clips. Here, a predicted highlight score may be H^{low}. Alternatively, a predicted highlight score may be H^{high}. Alternatively, a predicted highlight score may include H^{low} and H^{high}.

In addition, a highlight detection result is calculated as a highlight score for each clip H₁ in the final layer of a network, and an initial anchor point may be set based on this score. In this case, clips with a high score may be gathered together, so all clips may be divided first into blocks at a certain interval, and a clip with the highest highlight score in each block may be set as an initial anchor point. This initial anchor point becomes a criterion for finding an important moment in a moment retrieval task, and may derive a clip with a high highlight score to be selected preferentially.

The influence of a token may be traced, and learning may be performed through the following token influence loss function so that each clip may pay greater attention to a relevant token.

$${L}_{ti} = max ( 0 , Δ + P \cdot {S}^{low} - P \cdot {S}^{high} ) \\ Δ : margin$$

S^{low} may be the token influence degree of clips that must have a low highlight score value. S^{high} may be the token influence degree of clips that must have a high highlight score value.

A loss function for moment retrieval learning may be as follows.

$${L}_{mr} = {λ}_{L 1} ‖ m - \hat{m} ‖ + {λ}_{gIoU} {L}_{gIoU} ( m , \hat{m} ) + {λ}_{CE} {L}_{CE} \\ {λ}_{L 1} , {λ}_{gIoU} , {λ}_{CE} : Weights of each loss function \\ {L}_{gIoU} : gIoU loss \\ {L}_{CE} : Cross - entropy loss \\ m , \hat{m} : Actual interval , predicted interval$$

The entire loss function for learning may be as follows.

$$L = {L}_{mr} + {L}_{hd} + {λ}_{ti} {L}_{ti} \\ {λ}_{ti} : Weighting of the token impact loss function$$

The present disclosure is designed to perform video moment retrieval and highlight detection tasks simultaneously through this network structure and learning method, and each technique may operate in a complementary way to enable a precise interaction between a text and a video.

The present disclosure may provide the following excellent effects compared to the existing video moment retrieval (MR) and highlight detection (HD) techniques.

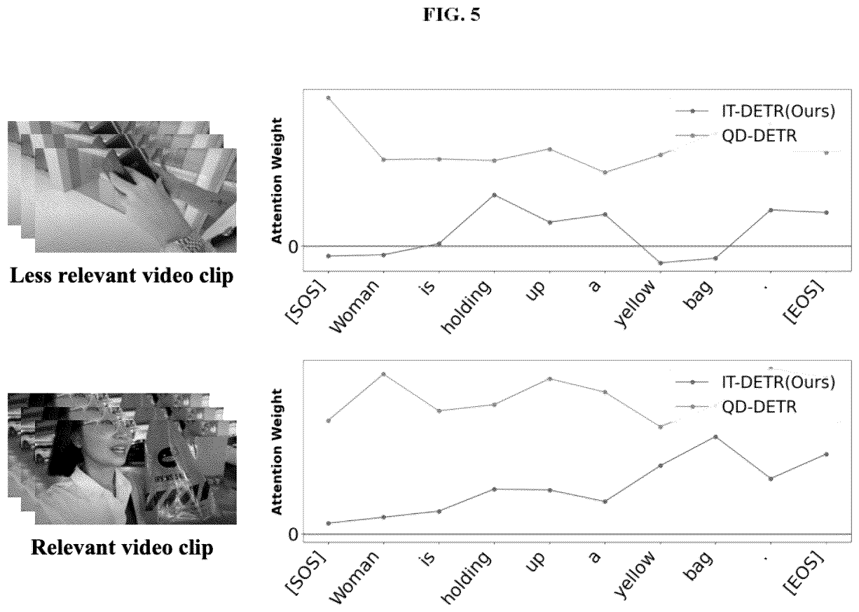

FIG. 5 shows alignment refinement effects due to inverted token augmentation.

### [Precise Alignment of Texts and Videos]

The existing MR and HD techniques were a method in which the information of all text tokens is propagated to all video clips with the same importance without sufficiently considering an interaction between a text query and a video clip. This method caused a problem that unnecessary information is transmitted even to a clip with a low relevance to a query. An inverted token augmentation technique proposed in the present disclosure may control an interaction between a text and a video clip more precisely by simultaneously using the original token and the inverted token of a text query. It may cause a clip with a high relevance to a query to focus on an original token and cause a clip with a low relevance to focus on an inverted token, refining alignment between a text and a video.

As shown in FIG. 5, the existing method QD-DETR uniformly generates a high weight even for a video clip irrelevant to a given sentence “Woman is holding up a yellow bag.”, and a proposed method even generates a weight less than 0 (negative attention) not to pay attention to words in a query irrelevant to a clip. On the other hand, it generates a high attention weight for the following clip with a high relevance, and in particular, it generates a high attention weight for a main object ‘yellow bag’, so it may be confirmed that it is aligned well with a highly relevant word.

As shown in Table 2, it may be confirmed that moment retrieval performance decreases by about 2.6% and highlight detection performance decreases by about 1% to 1.9% when an inverted token augmentation method is excluded from the entire model, so it may be confirmed that a proposed inverted token augmentation method plays an important role in the entire method.

[Retrieval Performance Improvement with Highlight-Guided Anchor Initialization]

A highlight-guided anchor initialization technique may be an original method for setting an initial anchor point in a moment retrieval task based on the result of highlight detection that detects the important moment of a video. Through this, an important moment is retrieved preferentially, and duplicate information or an unnecessary moment may be prevented from being selected. The existing method had a high possibility of missing an important moment due to random anchor point settings, but in the present disclosure, an anchor point may be set based on a highlight score, greatly improving retrieval accuracy.

As may be seen in Table 2, even when highlight-guided anchor initialization is removed, moment retrieval performance may decrease by about 1.5% and highlight detection performance may decrease by about 0.7% to 1.5%. Through this, it may be confirmed that a highlight-guided anchor initialization method is effective not only for moment retrieval but also for highlight detection.

TABLE 2
Performance Evaluation For Each Element

| | MR | HD | |
|---|---|---|---|
| | mAP | mAP | HIT@ 1 |
| Method | (Avg.) | (>=Very Good) | |
| (a) IT-DETR | 47.17 | 40.63 | 65.55 |
| (b) - Inverted Token Augmentation | 44.53 | 39.59 | 63.68 |
| (c) - Token Influence Tracing | 46.15 | 39.86 | 63.23 |
| (d) - HD-guided Block-wise Anchor | 45.68 | 39.91 | 64.00 |
| Initialization | | | |

### [Performance Verification Through Experimental Results]

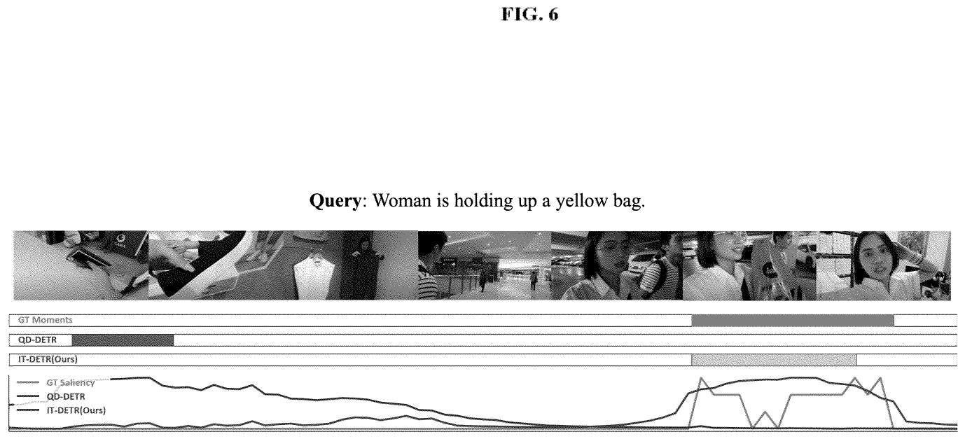

FIG. 6 shows the moment retrieval and highlight detection performance comparison with the prior art.

The effects of the present disclosure has been verified through an experiment from widely used datasets such as QVHighlights [1], TACOS [3], TVSum [4], etc. As the result of an experiment, the present disclosure showed superior performance to the existing state-of-the-art techniques, and in particular, retrieval performance and detection accuracy were greatly improved through a precise interaction between a text query and a video clip and a highlight-guided anchor initialization technique.

On the QVHighlights dataset, the present disclosure recorded higher performance than the existing techniques in both Moment Retrieval and Highlight Detection tasks. For example, the present disclosure showed 66.26% of performance in R1@0.5 and 52.58% of performance in R1@0.7, which may be a better result than the existing QD-DETR [2] (62.68%, 46.66%) and other state-of-the-art techniques. In addition, it also recorded 65.61% of performance in HIT@1 in highlight detection, which may be performance above the existing model.

In the TACOS dataset, the present disclosure showed much higher performance than the existing techniques in the Moment Retrieval task. The present disclosure recorded 41.66% in R1@0.5 and 25.27% in R1@0.7, significantly surpassing the existing state-of-the-art technique UVCOM [5] (36.39%, 23.32%). It may prove that the inverted token augmentation technique and the highlight-guided anchor initialization technique of the present disclosure are effective in processing an interaction between a text query and a video clip very precisely.

On the TVSum dataset, the present disclosure showed excellent performance in a highlight detection task, and in particular, showed an excellent ability to accurately detect an important moment. In the HIT@1 performance index, the present disclosure recorded 86.5% of performance, which may show very competitive performance compared to the existing UVCOM [5] (86.3%) and Task Weave [6] (87.3%).

The video moment retrieval and highlight detection device of the present disclosure may include a text encoder that obtains the original token of a text query, an inverter that obtains the inverted token of the text query based on the original token, a video encoder that obtains video feature vectors of video clips, and a cross-attention transformer that performs an interaction between the text query and the video clips by simultaneously using the original token, the inverted token and the video feature vectors.

The video moment retrieval and highlight detection device of the present disclosure may obtain the final feature of each clip of the video clips based on a final token obtained through the interaction.

The video moment retrieval and highlight detection device of the present disclosure may further include an influence tracer that traces the influence of the original token and the inverted token.

The above-described disclosure is described based on a series of steps or flow charts, but it does not limit the time series order of the present disclosure and if necessary, it may be performed at the same time or in different order. In addition, each component (e.g., a unit, a module, etc.) configuring a block diagram in the above-described disclosure may be implemented as a hardware device or software and a plurality of components may be combined and implemented as one hardware device or software. The above-described disclosure may be recorded in a computer readable recoding medium by being implemented in the form of a program instruction which may be performed by a variety of computer components. The computer readable recoding medium may include a program instruction, a data file, a data structure, etc. solely or in combination. An example of a computer readable recoding medium includes magnetic media such as a hard disk, a floppy disk and a magnetic tape, optical recording media such as a CD-ROM and a DVD, magneto-optical media such as a floptical disk and a hardware device which is specially configured to store and execute a program instruction such as ROM, RAM, a flash memory, etc. The hardware device may be configured to operate as at least one software module in order to perform processing according to the present disclosure and vice versa. A device according to the present disclosure may have program instructions for storing or transmitting a bitstream generated by the above-described encoding method.

What is claimed is:

1. A video moment retrieval and highlight detection method, comprising:
obtaining an inverted token of a text query based on an original token of the text query;
obtaining video feature vectors of video clips; and
performing an interaction between the text query and video clips by simultaneously using the original token, the inverted token and the video feature vectors.

2. The video moment retrieval and highlight detection method of claim 1, wherein the inverted token is generated by reversely converting a sign of the original token.

3. The video moment retrieval and highlight detection method of claim 1, wherein the interaction is performed by a cross-attention layer.

4. The video moment retrieval and highlight detection method of claim 1, wherein the video moment retrieval and highlight detection method further includes obtaining a final feature of each clip of the video clips based on a final token obtained through the interaction.

5. The video moment retrieval and highlight detection method of claim 4, wherein:
when a query token of the text query is more similar to a second key token generated from the original token than a first key token generated as the inverted token, the final feature is added to the final token and obtained by using a value token as a positive weight.

6. The video moment retrieval and highlight detection method of claim 5, wherein:
when the query token of the text query is more similar to the first key token generated as the inverted token than the second key token generated from the original token, the final feature is added to the final token and obtained by using the value token as a negative weight.

7. The video moment retrieval and highlight detection method of claim 6, wherein:
when the query token of the text query is irrelevant to a key token, the value token does not influence obtaining of the final feature.

8. The video moment retrieval and highlight detection method of claim 4, wherein the video moment retrieval and highlight detection method further includes:
calculating a highlight score based on a similarity between a global token obtained based on the interaction and the final feature; and
setting an initial anchor point for moment retrieval based on the highlight score.

9. The video moment retrieval and highlight detection method of claim 8, wherein:
setting the initial anchor point is performed by dividing the video clips into blocks having a certain interval, selecting a clip receiving a highest highlight score from each block and setting the clip as an initial anchor point of each block.

10. The video moment retrieval and highlight detection method of claim 8, wherein a method for obtaining the similarity is learned through a highlight score calculation loss function.

11. The video moment retrieval and highlight detection method of claim 10, wherein the highlight score calculation loss function uses a predicted highlight score of the video clips.

12. The video moment retrieval and highlight detection method of claim 11, wherein the predicted highlight score is at least one of a predicted highlight score of video clips that must have a low highlight score value or a predicted highlight score of video clips that must have a high highlight score value.

13. The video moment retrieval and highlight detection method of claim 1, wherein the interaction is performed based on a model learned by tracing an influence of the original token and the inverted token.

14. The video moment retrieval and highlight detection method of claim 13, wherein tracing the influence of the original token and the inverted token is performed to ensure that:
for a video clip with a high relevance among the video clips, the clip is relatively more influenced by the original token, and
for a video clip with a low relevance among the video clips, the clip is relatively more influenced by the inverted token.

15. The video moment retrieval and highlight detection method of claim 14, wherein the model is learned by utilizing a result of tracing the influence of the original token and the inverted token and a token influence loss function.

16. The video moment retrieval and highlight detection method of claim 15, wherein the token influence loss function is a function that uses an influence received from a token relevant to a video clip and an actual highlight score value of the video clip.

17. A video moment retrieval and highlight detection device, comprising:
a text encoder for obtaining an original token of a text query;
an inverter for obtaining an inverted token of the text query based on the original token;
a video encoder for obtaining video feature vectors of video clips; and
a cross-attention transformer for performing an interaction between the text query and the video clips by simultaneously using the original token, the inverted token and the video feature vectors.

18. The video moment retrieval and highlight detection device of claim 17, wherein the video moment retrieval and highlight detection device obtains a final feature of each clip of the video clips based on a final token obtained through the interaction.

19. The video moment retrieval and highlight detection device of claim 17, wherein the video moment retrieval and highlight detection device further includes an influence tracer for tracing an influence of the original token and the inverted token.

20. The video moment retrieval and highlight detection device of claim 17, wherein the interaction is performed based on a model learned by tracing an influence of the original token and the inverted token.
